(19) United States
(12) Patent Application Publication
(10) Pub. No.: US 2010/0059243 A1
(43) Pub. Date: Mar. 11, 2010

(54) Anti-electromagnetic interference material arrangement

(76) Inventor: Jin-Hong Chang, Hsin Ying City (TW)

Correspondence Address: PRO-TECHTOR INTERNATIONAL SERVICES, 20775 NORADA CT., SARATOGA, CA, 95070, US

(21) Appl. No.: 12/207,107

(22) Filed: Sep. 9, 2008

(51) Int. Cl. H01B 11/06

(52) U.S. Cl. 174/36

(57) ABSTRACT

Anti-EMI material arrangement, comprising a plurality of electrically conducting elongated particles, which are irregularly distributed within a substrate, forming a web of electrically conducting paths, so that incoming electromagnetic waves are attenuated. Optionally, spherical particles are added. Furthermore, optionally, absorbing particles are added to dissipate energy of electromagnetic waves.

### FIELD OF THE INVENTION

The present invention relates to an anti-EMI (electromagnetic interference) material arrangement, particularly to an anti-EMI material arrangement which uses a body of plastics, resin, synthetic textile fiber or cement, so that objects or surfaces are generated which attenuate electromagnetic waves across a broad range of wavelengths.

### BACKGROUND OF THE INVENTION

In recent years, electronic technology has undergone fast development. Various products for communication have been in use, which add to the convenience of life, but are susceptible to interference from electric and magnetic fields.

Electromagnetic waves are generated by electronic devices which operate at high frequencies, interfering with other device if placed too closely to the latter and if no protective or shielding measures have been taken. Unshielded electronic devices are not only prone to interfere with other devices, but are also disturbed in proper functioning by electromagnetic interference (EMI). Furthermore, human health is affected by EMI, so that standards in many countries for preventing EMI have become stricter.

Electromagnetic waves are, depending on wavelengths thereof, generated in various ways. Longest electromagnetic waves are radio waves emanating from electric circuits, shortest electromagnetic waves are x-rays from cathode ray tubes. Visible light covers a range of wavelengths from 0.4 μm to 0.76 μm. At shorter wavelengths, ultraviolet light is found. With decreasing wavelength, electromagnetic waves become more energetic and more harmful for human cells, in particular, DNA.

Damage to humans by electromagnetic waves with longer wavelengths, like mobile phones, power transformer stations and power transmission cables is still disputed. However, exposure to electromagnetic waves of high intensity possibly has the following consequences:
1. Flow of electric current through cell material, changing electric cell potential;
2. healing of water in tissue, similar to the effect of microwave ovens, heating tissue;
3. changing magnetic induction in cells; and
4. affecting blood vessels, endocrine glands and reproductory organs, reducing blood platelets and leukocytes, and causing neurasthenia, bulbus oculi and tumors.

Due to the broad spectrum of electromagnetic waves, protection is complex. Regular electric devices have plastics cases which do not shield against EMI. Common measures against EMI include the following:

1. Metal cases of electrically highly conductive material, like aluminium-magnesium alloy are effective against EMI, but production cost is high, typically tens of times higher than plastics cases. Furthermore, reflection, diffraction and creeping effects, lead to decreased protection, depending on directions of incoming electromagnetic waves.

2. Protective plates made of electrically highly conductive material, like nickel and silver, which are glued on plastics cases, are less costly than metal cases. However, thickness of cases is thereby increased, and reflection, diffraction and creeping effects, lead to decreased protection.

3. Galvanizing surfaces of cases with one or more electrically conductive layers provides protection by conductivity, but is banned in Europe and the United States due to environmental concerns.

4. Coating surfaces of cases with electrically conductive paint also faces environmental problems. Furthermore, products of high quality and stability are rare.

5. Creating an electrically conductive layer by electrostatic discharge (ESD) is a popular technique, but is, due to a need for a low-temperature sputtering apparatus, expensive and time-consuming.

6. Creating a layer by electrostatic discharge which attenuates electromagnetic waves by dielectric and magnetic resonance does not entirely absorb electromagnetic waves, so that a reflecting plate has to be attached to a rear side to increase attenuation. Furthermore, electrostatic discharge layers absorb only parts of the electromagnetic spectrum, so that no complete protection is achieved.

To summarize, conventional art for protection against EMI is expensive, results in increased thickness of cases and is only partially effective due to reflection, diffraction and creeping effects.

### SUMMARY OF THE INVENTION

The main object of the present invention is to provide an anti-EMI material arrangement (particle-dielectric composites) which which uses a body of plastics, resin, synthetic textile fiber or concrete, so that objects or surfaces are generated which absorb electromagnetic waves across a broad range of wavelengths.

To achieve above object, the present invention the present invention is an arrangement of anti-EMI material consisting of at least one kind of particles which are electrically conducting and at least partly have an elongated shape, so that a web of conducting paths is generated, which attenuates incoming electromagnetic waves. The elongated particles are carbon nanotubes, carbon fibers or fibric nano-carbon, or very thin conducting wires which are mixed with a substrate.

In another embodiment, the present invention has both elongated particles and spherical particles, so that an interwoven spatial structure of conducting paths is created. Hence, electromagnetic waves passing through the substrate will be attenuated across abroad range of wavelengths.

The spherical particles are made of graphite, bamboo-shaped carbon, C60 molecules, active carbon or carbon nano-spheres. Alternatively, the spherical particles are of gold, silver, copper, iron, pig iron, nickel, tin silicon or silicon-iron, or a combination thereof with carbon. The main effect of electrically conducting paths is to lead away energy from incoming electromagnetic waves to ground and thus to block EMI.

Furthermore, an anti-EMI effect is also achieved by mixing conducting particles with particles that attenuate incoming electromagnetic waves by dissipating energy thereof into heat due to electric and magnetic resistance. Reflection and diffraction of electromagentic waves within the substrate is thereby prevented. Attenuating particles are of metal oxide, photocatalyst material, magnetic powder, calcium carbonate, cement or natural minerals which is effective in the far-infrared range. Therein, metal oxide powder includes aluminium oxide, zinc oxide, titanium dioxide, photocatalysts or iron oxides, or mixtures thereof. Magnetic material powder includes magnetic metal oxides. Natural minerals include cement powder, potter's clay, clay, calcium carbonate, or minerals containing metal, or mixtures thereof.

Employing both electrically conducting particles and absorbing particles is effective for electromagnetic shielding, without reflection, diffraction and creeping effects.

The substrate preferably is a polymer, including plastics and synthetic rubber. The substrate is produced by injection molding or another suitable process. Anti-EMI material is preferably added during synthesizing of the polymer.

Alternatively, anti-EMI material is added when the polymer is available as a powder and ready to be molten and injection molded, and a sphere is formed out of the resulting mixture. In another method, when the polymer is available as a sphere, the sphere is broken and anti-EMI material is added, or anti-EMI material is directly inserted into the sphere, and the resulting mixture is prepared for injection molding or another working process. In a further method, anti-EMI material is added to a polymer sphere, resulting in a high-concentration-mixture, which subsequently is added to a polymer sphere to yield a regular mixture, which in turn is prepared for injection molding or another working process. For example, in the regular mixture, anti-EMI material is mixed with a polymer at a weight ratio of 5%. The high-concentration-mixturc has a weight fraction of anti-EMI material of 25%, which is five times higher than the regular mixture and is to be mixed with polymer of four times as much weight to yield the intended regular mixture with a weight fraction of anti-EMI material of 5%.

The substrate is shaped like a case, a plate or a tube, allowing for a plurality of applications.

Furthermore, the substrate alternatively is a resin coating, which is attached to plastics, textile, metal, wood, glass or walls of buildings or tubes or cables to obtain a protective effect from EMI.

Furthermore, the substrate alternatively is a synthetic textile fiber for obtaining EMI-resistant textile material.

Furthermore, the substrate alternatively is cement powder for obtaining EMI-resistant building material.

The present invention uses conducting particles or a mixture of conducting particles with particles that dissipate energy of electromagnetic waves into heat, preventing reflection and diffraction by conducting particles.

Conducting particles are made of carbon or metal, or a combination thereof. Dissipative particles are made of metal oxide, magnetic powder, natural minerals, or a combination thereof.

Thereby a variety of anti-EMI materials is created for attenuating and absorbing incoming electromagnetic waves.

Anti-EMI material is added to plastics or synthetic rubber, which is regularly produced by injection molding or another suitable process, so that cases are manufactured which provide shielding against EMI across a broad spectrum without additional elements.

Using the anti-EMI material arrangement of the present invention within coatings is applicable to electric devices, wood, cement, glass, plastics, textiles, construction materials, paper, in sheets or tubes, on inner or outer surfaces thereof. For application to synthetic textiles, anti-EMI material is applied to surfaces thereof or directly inserted into fibers thereof.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a cross-sectional schematic illustration of the anti-EMI material arrangement of the present invention in the first embodiment.

FIG. 2 is a cross-sectional schematic illustration of the anti-EMI material arrangement of the present invention in the second embodiment.

FIG. 3 is a cross-sectional schematic illustration of the anti-EMI material arrangement of the present invention in the third embodiment.

FIG. 4 is a cross-sectional schematic illustration of the anti-EMI material arrangement of the present invention in the forth embodiment.

FIG. 5 is a cross-sectional schematic illustration of the anti-EMI material arrangement of the present invention embodied as a case.

FIG. 6 is a schematic illustration of the function of the anti-EMI material arrangement of the present invention embodied as a plate.

FIG. 7 is a cross-sectional schematic illustration of the anti-EMI material arrangement of the present invention embodied as a tube.

FIG. 8 is a picture taken with an electron microscope of the anti-EMI material arrangement of the present invention, with elongated and spherical nano-particles.

FIG. 9 is a picture taken with an electron microscope of a conventional anti-EMI material arrangement with spherical nano-particles only.

### DESCRIPTION OF THE PREFERRED EMBODIMENTS

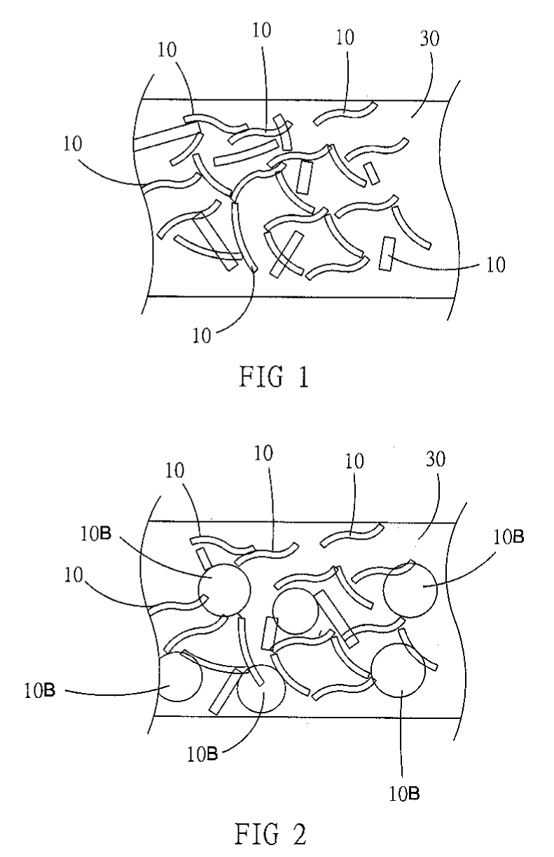

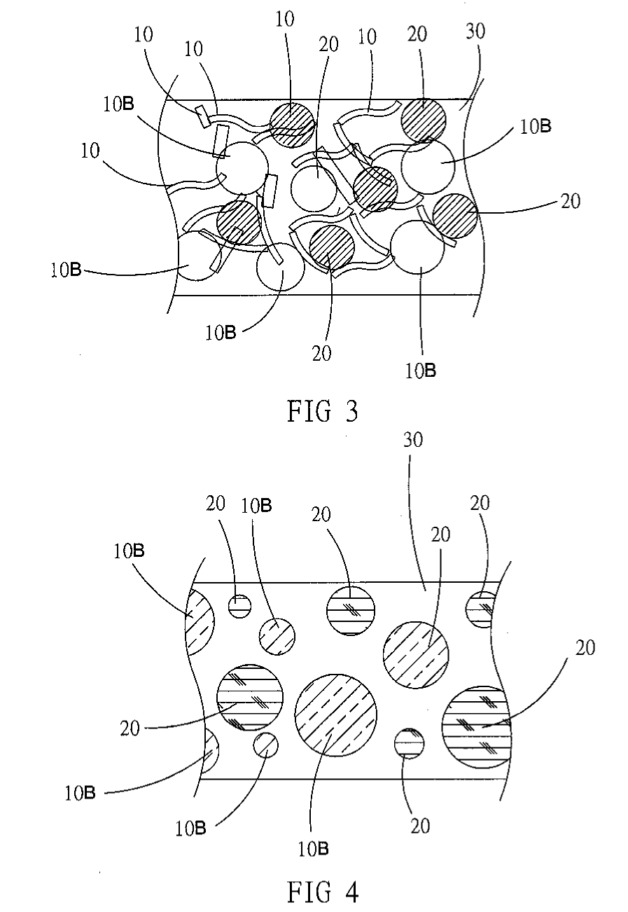

As shown in FIG. 1, the present invention is an arrangement of anti-EMI material consisting of particles which are mixed in plastics, synthetic rubber, resin, cement or synthetic textile fiber to absorb electromagnetic waves across a broad range of wavelengths, so that cases and textiles are enabled to protect from electromagnetic waves.

The electrically conducting particles of the anti-EMI material of the present invention are at least of one kind of electrically conductive material and have tube-like, elongated or irregular shapes or a mixture thereof.

The anti-EMI material of the present invention is effective against EMI by providing interweaved conductive paths formed by the electrically conducting particles and by preventing reflection, diffraction and creeping effects due to absorbing particles. The absorbing particles of the present invention are made of metal oxide, photo-catalyst, magnetic powder, calcium carbonate, cement, or natural mineral with an effect of absorbing electromagnetic waves.

As shown in FIG. 1, in a first embodiment, anti-EMI material of the present invention has elongated particles 10 of tube-like shapes of at least one kind. The elongated particles 10 are with irregular orientations immersed in a substrate 30, so that several of elongated particles 10 are respectively connected at ends thereof and an interwoven web of conducting paths is created. Hence, electromagnetic waves passing through the substrate 30 will be attenuated.

The elongated particles 10 are carbon nano-tubes, carbon fibers or fibric nano-carbon, or very thin conducting wires which are mixed with the substrate 30.

The interwoven web of conducting paths conductive paths generated by the mutually connected elongated particles 10 and reaching through the substrate 30 more effectively prevent EMI than particles which are not connected with each other.

As shown in FIG. 2, in a second embodiment, anti-EMI material of the present invention has both elongated particles 10 and spherical particles 10B. The spherical particles 10B have various diameters. The elongated particles 10 and the spherical particles 10B are immersed in the substrate 30, so that an interwoven spatial structure of conducting paths is created. Hence, electromagnetic waves passing through the substrate 30 will be attenuated.

The spherical particles 10B are made of graphite, bamboo-shaped carbon, C60 molecules, active carbon or carbon nano-spheres. The elongated and spherical particles 10, 10B are produced by carbon undergoing a high-temperature reaction to obtain electric conductivity and being grinded into tiny particles of elongated and spherical shapes. Alternatively, the spherical particles 10B are of gold, silver, copper, iron, pig iron, nickel, tin silicon or silicon-iron.

The working of an irregular arrangement of particles of various shapes is shown in electron microscope images.

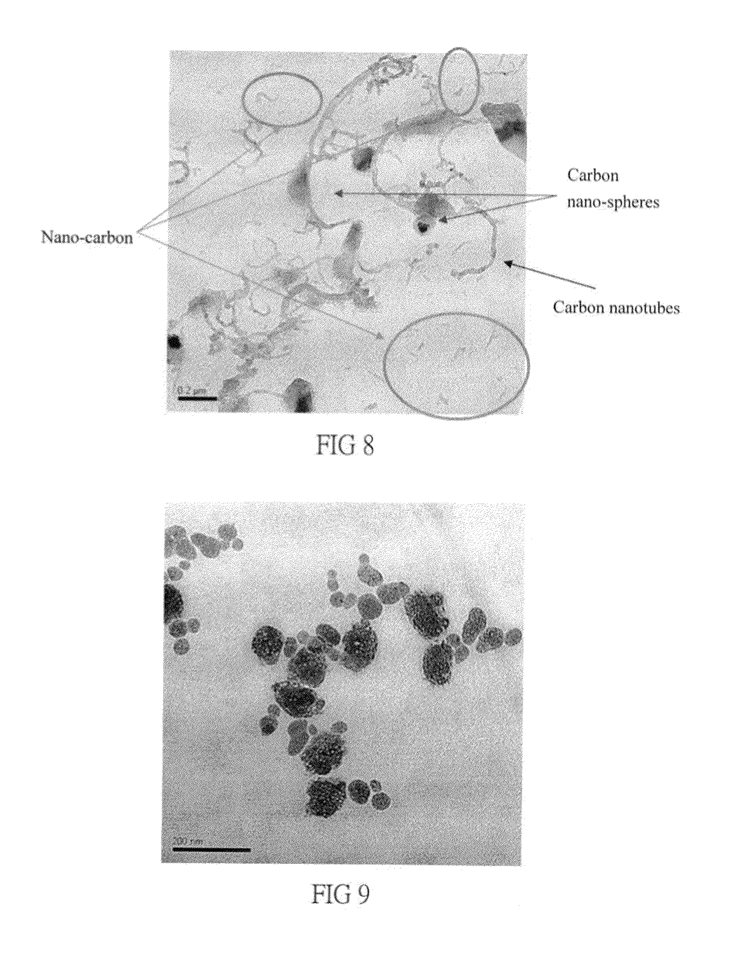

As shown in FIG. 8, if nano-tubes, splinters and spheres are randomly mixed with a plastics substrate, then an irregular web of conducting paths is created which provides effective shielding of electromagnetic waves.

As shown in FIG. 9, if nano-spheres alone are mixed with a plastics substrate, then conducting paths of shorter lengths is created which provides less effective shielding of electromagnetic waves, as compared to the first and second embodiments of the present invention.

Mixing the elongated particles 10 and the spherical particles 10B with the substrate 30 increases the electric conductivity of the substrate 30, so that electromagnetic waves which pass through will be attenuated. Since reflection, diffraction and creeping effects are thereby not prevented, in a third embodiment of the present invention absorbing particles 20 are further added, which absorb electromagnetic waves reflected by the elongated and spherical particles 10, 10B, converting electromagnetic field energy to heat.

When the absorbing particles 20 are passed through by electromagnetic waves, energy thereof is dissipated into heat by electric and magnetic resistance, as well as resonance and dielectric effects. The absorbing particles 20 are of metal oxide powder, including aluminium oxide, zinc oxide, titanium dioxide, photocatalysts or iron oxides, e.g., Fe₃O₄, which, having high electric resistance and high dielectric constant values, dissipate electromagnetic radiation. Alternatively, the absorbing particles 20 are of magnetic material powder, e.g., neodymium-boron alloy or ferrites, which dissipate electromagnetic radiation by magnetic resonance. Alternatively, the absorbing particles 20 are of natural minerals, cement powder, potter's clay, clay, calcium carbonate, or minerals containing silicon, iron, aluminium, nickel, carbon, magnesium, manganese or Chromium, or minerals which are effective in the far-infrared range. Suitable natural minerals include tourmaline, porphyritic andesite, quartz and glimmer. Absorption of electromagnetic waves is achieved by high a electric resistance and a high dielectric constant.

Referring to FIG. 4, the anti-EMI material arrangement of the present invention in a forth embodiment has spherical particles 10B and absorbing particles 20. Even though elongated particles are not used, a mixture of conducting particles and absorbing particles is more effective for electromagnetic shielding than either component alone.

Research has shown that shielding effects at various wavelengths depend on diameters of conducting spherical particles and absorbing particles. Therefore the spherical particles 10B and absorbing particles 20 of the present invention, due to having various diameters, effectively attenuate electromagnetic waves across a broad range of wavelengths. Electromagnetic waves of very short wavelengths are shielded by spherical particles 10B and absorbing particles 20 having diameters between 1 nm and 100 nm.

The substrate 30 is made of polymer, resin, synthetic fiber or cement.

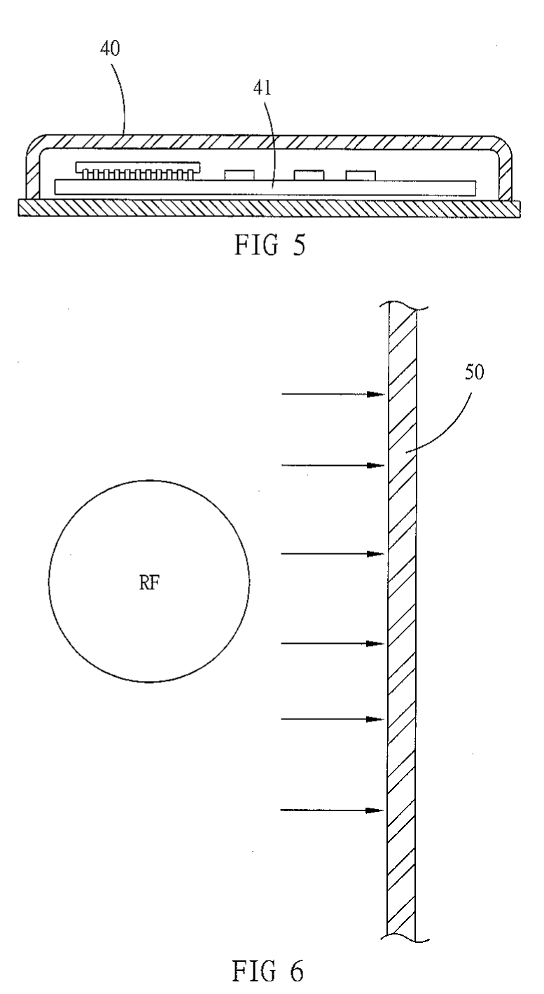

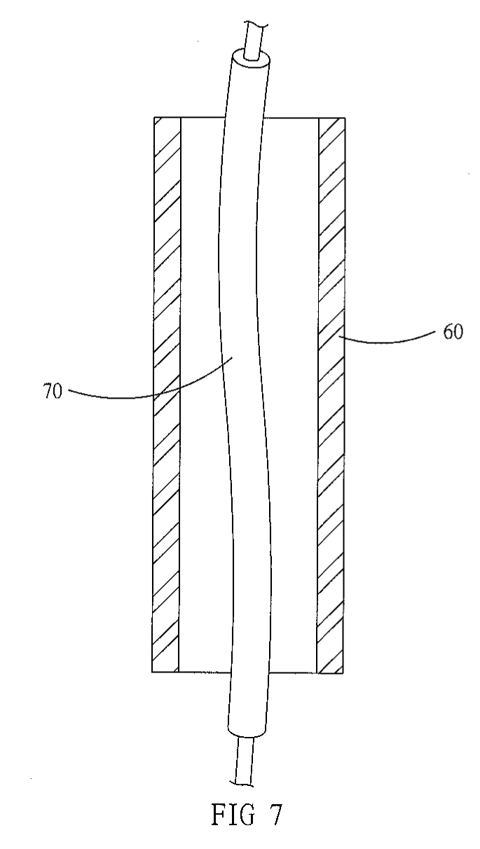

Preferred polymers for the substrate 30 include PC, PE, polyester, PVC, ABS, PT, PU, nylon, acrylic resin, synthetic rubber, synthetic sponge and silicon. The substrate is produced by injection molding or another suitable process and is shaped into a case, a plate or a tube, allowing for a plurality of applications. As shown in FIG. 5, the substrate is a case 40, protecting an electronic device 41 from EMI. As shown in FIG. 7, the substrate is a tube 60, protecting a cable 70 from EMI or, vice versa, shielding an environment from EMI originating from the cable 70.

Furthermore, the substrate 30 alternatively is a resin coating, which is attached to plastics, textile, metal, wood, glass or walls of constructions or tubes or cables to obtain a protective effect from EMI.

If the substrate 30 is a polymer, particles are inserted by one of the following methods. (1) During polymerization, particles are added. (2) After polymerization, when the polymer is available as a powder and ready to be molten and injection molded, particles are added as a powder and a sphere is formed out of the resulting mixture. (3) When the polymer is available as a sphere, the sphere is broken and particles are added, or particles are directly inserted into the sphere, and the resulting mixture is prepared for injection molding or another working process. (4) Particles are added to a polymer sphere, resulting in a high-concentration-mixture, which subsequently is added to a polymer sphere to yield a regular mixture, which in turn is prepared for injection molding or another working process. For example, in the regular mixture, particles are mixed with a polymer at a weight ratio of 5%, The high-concentration-mixture has a weight fraction of particles of 25%, which is five times higher than the regular mixture and is to be mixed with polymer of four times as much weight to yield the intended regular mixture with a weight fraction of particles of 5%.

If the polymer is synthetic rubber or sponge, particles are preferably added during production thereof.

If the substrate 30 is made of synthetic textile, particles are preferably added during synthetization, forming a mother sphere, or added when fibers are drawn.

If the substrate 30 is made of cement, adding of particles results in walls and separators which shield against EMI.

The anti-EMI material arrangement of the present invention provides the substrate thereof with electromagnetic shielding capabilities across a broad wavelength range. As compared to conventional art, the present invention has a spatial structure with long-ranging electrically conducting paths. By using both particles that conduct electricity and particles that absorb electromagnetic radiation, EMI is entirely eliminated across a broad wavelength range. The present invention is directly incorporated into the substrate 30, allowing producing cases or other protective elements to be performed in a conventional way, so that production costs are saved. The present invention is also applicable to coatings, so that EMI protection is provided for a wide range of daily objects.

1. An anti-EMI material arrangement, comprising:
a substrate; and
a plurality of particles of at least one kind distributed within said substrate, which are electrically conducting particles and at least partly comprise elongated conducting particles, so that a web of electrically conducting paths is formed inside said substrate, so that incoming electromagnetic waves are attenuated.

2. The anti-EMI material arrangement of claim 1, wherein said elongated conducting particles are made of carbon nano-tubes, active carbon fibers, carbon fibers, nano-carbon, electrically conducting carbon of other shapes, metal wires or elongated electrically conducting elements, or a combination thereof.

3. The anti-EMI material arrangement of claim 1, wherein said electrically conducting particles besides said elongated conducting particles comprise spherical conducting particles, which are irregularly distributed within said substrate.

4. The anti-EMI material arrangement of claim 3, wherein said spherical conducting particles have various sizes of irregular distribution and are made of carbon, including bamboo-shaped carbon, C60 molecules, active carbon, carbon nano-spheres or spherical electrically conducting elements, or a combination thereof.

5. The anti-EMI material arrangement of claim 3, wherein said spherical conducting particles are made of metal, including gold, silver, copper, iron, pig iron, nickel, tin silicon or silicon-iron, or a combination thereof.

6. The anti-EMI material arrangement of claim 3, wherein said spherical conducting particles comprise carbon spherical particles and metallic spherical particles, wherein said carbon spherical particles are made of bamboo-shaped carbon, C60 molecules, active carbon, carbon nano-spheres or spherical electrically conducting elements, or a combination thereof, and said metallic spherical particles are made of gold, silver, copper, iron, pig iron, nickel, tin silicon or silicon-iron, or a combination thereof.

7. The anti-EMI material arrangement of claim 1, wherein said particles besides said electrically conducting particles comprise absorbing particles, which absorb incoming electromagnetic waves and electromagnetic waves reflected and diffracted by said electrically conducting particles.

8. The anti-EMI material arrangement of claim 7, wherein said absorbing particles are made of metal oxides, including aluminium oxide, zinc oxide, titanium dioxide, photocatalysts or iron oxides, or a combination thereof.

9. The anti-EMI material arrangement of claim 7, wherein said absorbing particles are made of magnetic powder, including metals or magnetic metal oxides, or a combination thereof.

10. The anti-EMI material arrangement of claim 7, wherein said absorbing particles are made of natural minerals, including cement powder, potter's clay, clay or calcium carbonate, or a combination or natural minerals which is effective in the far-infrared range thereof.

11. The anti-EMI material arrangement of claim 1, wherein said substrate is made of polymer, including plastics or synthetic rubber, which is formed into a desired shape in a production method, which includes injection molding or another suitable step.

12. The anti-EMI material arrangement of claim 11, wherein said plurality of particles are added to said substrate during synthetization thereof.

13. The anti-EMI material arrangement of claim 11, wherein said plurality of particles are added to said substrate after, in said production process, said substrate has been formed into powder and is ready for injection molding.

14. The anti-EMI material arrangement of claim 11, wherein said plurality of particles are added to said substrate after, in said production process, said substrate has been synthesized and formed into powder to undergo later injection molding.

15. The anti-EMI material arrangement of claim 11, wherein said plurality of particles are added to said substrate to form a high-concentration mixture, which is subsequently mixed with substrate material to undergo later injection molding.

16. The anti-EMI material arrangement of claim 11, wherein said desired shape of said substrate is a case housing an electronic device.

17. The anti-EMI material arrangement of claim 11, wherein said desired shape of said substrate is a plate or tube for shielding against electromagnetic interference.

18. The anti-EMI material arrangement of claim 1, wherein said substrate is a resin coating, which is attached to wood, cement, glass, plastics, textiles, construction materials or metal, in sheets or tubes or cables, on inner or outer surfaces thereof to obtain a protective effect from electromagnetic interference.

19. The anti-EMI material arrangement of claim 1, wherein said plurality of particles are applied to surfaces of synthetic textiles or inserted into fibers of synthetic textiles to obtain a protective effect from electromagnetic interference.

20. The anti-EMI material arrangement of claim 1, wherein said substrate is made of cement.

21. An anti-EMI material arrangement, comprising:
a substrate; and
a plurality, of particles, irregularly distributed within said substrate, comprising spherical conducting particles of at least one kind, which attenuate incoming electromagnetic waves, and absorbing particles of at least one kind, which absorb incoming electromagnetic waves and electromagnetic waves reflected and diffracted by said spherical conducting particles, dissipating energy thereof into heat.

22. The anti-EMI material arrangement of claim 21, wherein said spherical conducting particles are made of carbon, including bamboo-shaped carbon, C60 molecules, active carbon, carbon nano-spheres or spherical electrically conducting elements, or a combination thereof.

23. The anti-EMI material arrangement of claim 21, wherein said spherical conducting particles are made of metal, including gold, silver, copper, iron, pig iron, nickel, tin silicon or silicon-iron, or a combination thereof.

24. The anti-EMI material arrangement of claim 21, wherein said absorbing particles are made of metal oxides, including aluminium oxide, zinc oxide, titanium dioxide, photocatalysts or iron oxides, or a combination thereof.

25. The anti-EMI material arrangement of claim 21, wherein said absorbing particles are made of magnetic powder, including metals or magnetic metal oxides, or a combination thereof.

26. The anti-EMI material arrangement of claim 21, wherein said absorbing particles are made of natural minerals, including cement powder, potter's clay, clay or calcium carbonate, natural minerals which are effective in the far-infrared range, or a combination thereof.
